(19) United States
(12) Patent Application Publication
(10) Pub. No.: US 2019/0079213 A1
(43) Pub. Date: Mar. 14, 2019

(54) Automatic Harbor Surveillance System

(71) Applicants: Iryna Dzieciuch, San Diego, CA (US); Michael Putnam, San Diego, CA (US); Greg Anderson, San Diego, CA (US)

(72) Inventors: Iryna Dzieciuch, San Diego, CA (US); Michael Putnam, San Diego, CA (US); Greg Anderson, San Diego, CA (US)

(73) Assignee: United States of America, as Represented by the Secretary of the Navy, Arlington, VA (US)

(21) Appl. No.: 15/702,858

(22) Filed: Sep. 13, 2017

(51) Int. Cl. G01V 9/00; G06N 3/04; G06N 3/08; B63B 22/00

(52) U.S. Cl. CPC G01V 9/00; G06N 3/0436; H04L 67/12; B63B 22/00; B63B 2022/006; G06N 3/08

(57) ABSTRACT

Systems and methods for harbor surveillance according to several embodiments of the present invention can include a plurality of buoys that are arranged in a harbor in a predetermined pattern. The buoys can have various components for computing buoy position data, including but not limited to an accelerometer, gyroscope, GPS, compass, and a transmitter. The buoys can be equidistant from each other, and in some embodiments, the buoys can be submerged. The buoy position data can be received by a remote receiver. A processor that is connected to the received can convert the buoy position data, or change in data due to movement of a buoy cause by a Kelvin wake, which is further due to vessel movement through the harbor, into a determination of vessel presence, course and speed, using a fuzzy neural network algorithm.

### FEDERALLY SPONSORED RESEARCH AND DEVELOPMENT

The United States Government has ownership rights in this invention. Licensing inquiries may be directed to Office of Research and Technical Applications, Space and Naval Warfare Systems Center, Pacific, Code 72120, San Diego, Calif., 92152; telephone (619) 553-5118; email: ssc_pac_t2@navy.mil, referencing 103747.

### FIELD OF THE INVENTION

The present invention pertains generally to harbor surveillance systems. More specifically, the present invention can pertain to systems and method for detecting objects moving on the water's surface using an array of sensing buoys. The present invention can be particularly, but not exclusively, useful as a harbor surveillance system that uses sensing buoys, which are equipped with a motion sensing detector and a data communication link. The buoys are able to record and send motion data readings from multiple sensors to a server. These readings can be analyzed in real-time by an artificial neural network algorithm, to discern Kelvin wake patterns created by moving objects.

### BACKGROUND OF THE INVENTION

Often times it is desirable to conduct harbor surveillance operations, for safety and security reasons. To do this, it is often desirable to be able to detect objects that are transiting through the harbor. One way to do this is by using radar. But radars can require an external source of power. Alternatively, cameras can be used to detect and record vessel harbor transits. But visual camera methods may not be particularly effective in fog and low visibility situations. And whatever method is used, it can be desirable to minimize the personnel required to operate and maintain such a harbor surveillance system.

Another method for harbor surveillance could be to take advantage of man-made Kelvin wakes on the surface of the water, which can be caused by vessels moving through a fluid (water). Kelvin wakes have been studied since the 1950's, however, there is no applied approach that describes how to unitize this knowledge for detecting moving objects of different types. Also, there is no exact scientific method that describes how to measure wake displacement, and convert that wake displacement into a reliable indication of a vessel's presence, even though physics of this phenomena has been described.

In view of the above, it can be an object of the present invention to provide systems and methods for harbor surveillance that can automatically monitor harbor traffic, without human operator intervention. Another object of the present invention can be to provide systems and methods for automatic harbor surveillance that can use Kelvin wake phenomena caused by vessels moving through the harbor, to determine the presence, course and speed of the vessel. Another object of the present invention can be to provide systems and methods for automatic harbor surveillance that can use the Kelvin wake phenomena to detect vessels in low visibility conditions, even if the vessels cannot be seen. Yet another object of the present invention can be to provide systems and methods for harbor surveillance that can use a low power, renewable energy source, and that can yield real-time notifications on vessel movement through the harbor. Still another object of the present invention can be to provide systems and methods for harbor surveillance that can be easily implemented in a cost-effective manner.

### SUMMARY OF THE INVENTION

Systems and methods for harbor surveillance according to several embodiments of the present invention can include a plurality of buoys that are arranged in a harbor in a predetermined pattern. The buoys can have various sub-components which can include an accelerometer, gyroscope, GPS, compass, and a transmitter, for computing buoy position data. The buoys can be equidistant from each other at a distance “d”, although in some cases (due to the geography of the harbor, for example), the buoys can have a different distance “dᵢ”. In some embodiments, the buoys can be submerged.

A receiver can receive the transmitted buoy position data for each buoy, and a processor can be connected to the receiver for manipulating the buoy position data set. The processor, using a fuzzy neural network algorithm set of non-transitory written instructions, can use the buoy position data, which can be caused by Kelvin wake(s) that are generated by objects in motion through the water, to determine if an object is present (or not) in the harbor. If an object is present, the systems and methods can determine the course and speed of the object.

### BRIEF DESCRIPTION OF THE DRAWINGS

The novel features of the present invention will be best understood from the accompanying drawings, taken in conjunction with the accompanying description, in which similarly-referenced characters refer to similarly-referenced parts, and in which:

FIG. 1 is a prior art, black-and-white aerial photograph, which illustrates Kelvin wake phenomena generated by an object passing through a fluid (vessel through water);

FIG. 2 is a prior art schematic of the Kelvin wake of FIG. 1;

FIG. 3 is a block diagram of the automatic harbor surveillance system of the present invention according to several embodiments;

FIG. 4 is a graph of translational buoy data versus time for a representational buoy from the system of FIG. 3;

FIG. 5 is a graph of rotational buoy data versus time for a representational buoy from the system of FIG. 3;

FIG. 6 is a block diagram that depicts input temporal displacement data and output data object characteristics data from the system of FIG. 3;

FIG. 7 is a block diagram that depicts input temporal displacement data and output data vessel type data from the system of FIG. 3;

FIG. 8A is a side elevational view of a top portion of a representative buoy from the system of FIG. 3;

FIG. 8B is a block diagram of the lower portion of the buoy of FIG. 4A, which can illustrate the component parts of the buoys for the system of FIG. 3 in greater detail; and,

FIG. 9 is a block diagram that is illustrative of steps that can be taken to accomplish some of the methods of the present invention according to several embodiments.

### DETAILED DESCRIPTION OF THE EMBODIMENTS

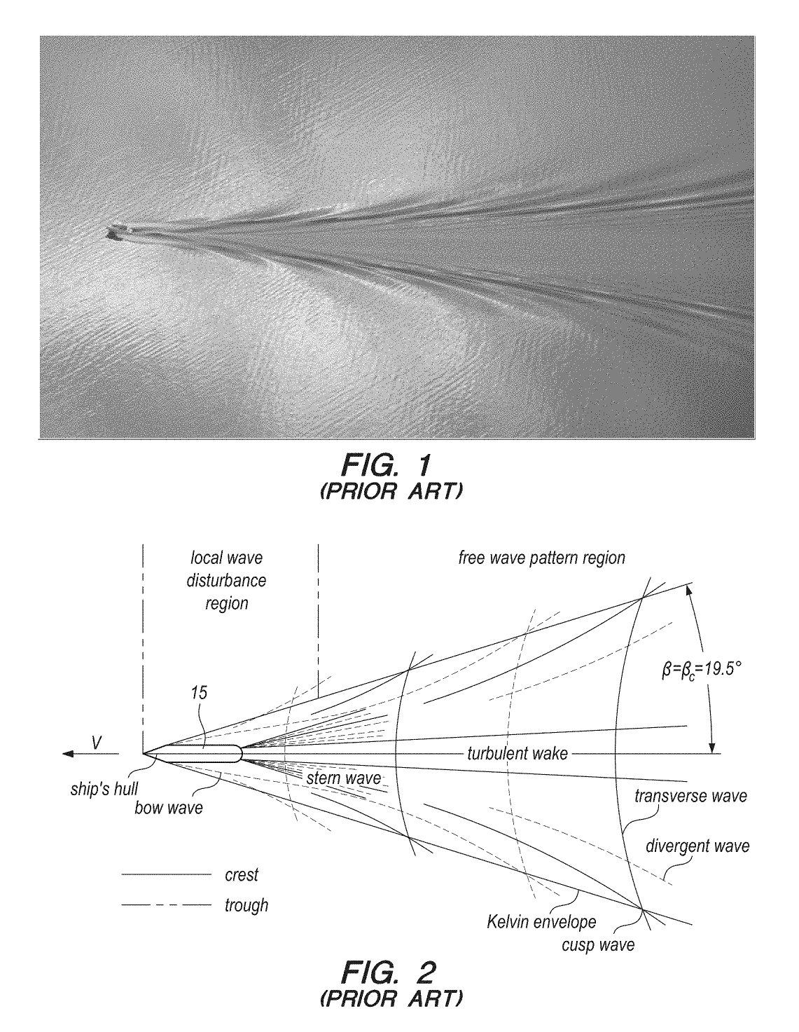

Referring initially to FIGS. 1-2 for a brief overview, from a fluid dynamics perspective, a wake can be thought of a wave pattern on the water surface that is downstream of an object in a fluid flow. The wake can be produced by a moving object (e.g. a ship), and can be caused by pressure differences of the fluids above and below the free surface and gravity (or surface tension), or both. For purposes of this disclosure, and referring to FIG. 1, waterfowl and boats or other objects moving across the surface of water can produce a wake pattern, first explained mathematically by Lord Kelvin and generally known in the prior art as a Kelvin wake pattern.

As shown in FIG. 2, a Kelvin wake pattern can consist of two wake lines that form the arms of a chevron, or “V”, with the source of the wake (vessel 15 in FIG. 2) at the vertex of the V. For sufficiently slow motion, each wake line can be offset from the path of the wake source by around arc sin (1/3)=19.47° and can be made up of feathery wavelets angled at roughly 53° to the path. The inside of the V in FIG. 2 (of total opening 39° as indicated above) can be filled with transverse curved waves, each of which is an arc of a circle centered at a point lying on the path at a distance twice that of the arc to the wake source. This pattern can be independent of the speed and size of the wake source over a significant range of values.

However, the pattern changes at high speeds (only), for example, above a hull Froude number of approximately 0.5. Then, as the source's speed increases, the transverse waves diminish and the points of maximum amplitude on the wavelets form a second V within the wake pattern, which grows narrower with the increased speed of the source. Parts of the pattern may be obscured by the effects of propeller wash, and tail eddies behind the stern or the boat, and by the boat being a large object and not a point source. Also, the water need not be stationary, but may be moving as in a large river. In such cases, the important consideration then can be the velocity of the water relative to a boat or other object causing a wake. But for a harbor/restricted waters scenario, such as a river passage, the Kelvin wake geometry remains sufficiently constant to allow the system and methods of the present invention to take advantage of the geometry.

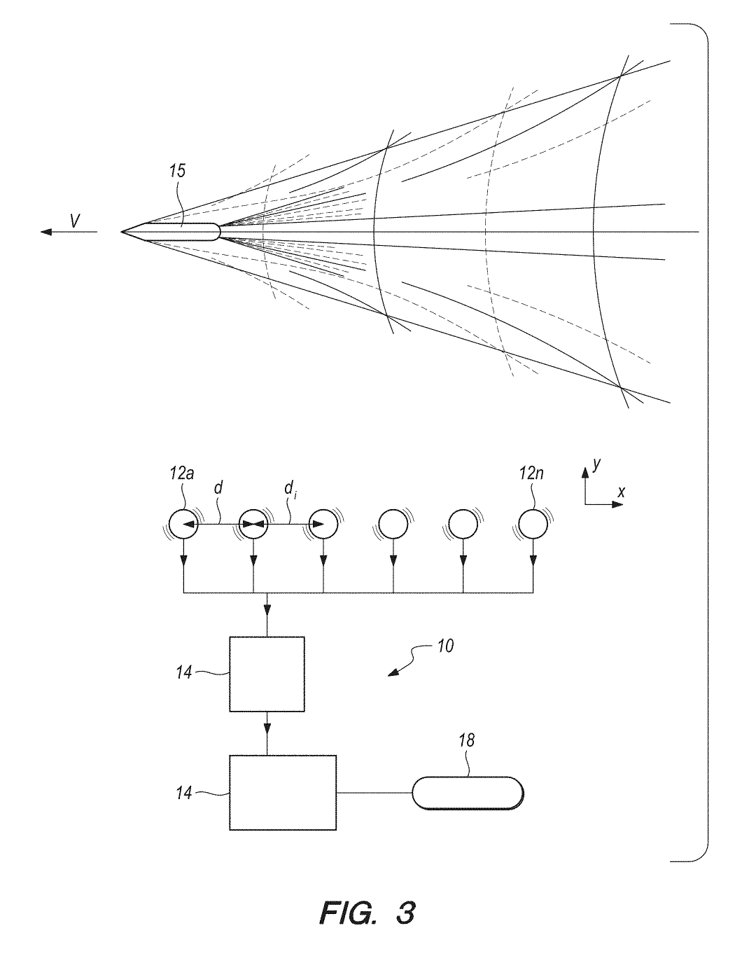

From the above, it can be seen that Kelvin wake phenomena can be used as a reliable predictor of vessel motions in a harbor over a wide range of objects and speeds. To take advantage of these phenomena, and referring now to FIG. 3, the harbor surveillance system of the present invention can be shown and can be generally designated by reference character 10. As shown system 10 can include a plurality of “smart” buoys 12a-12n. As used herein, the term “smart” can mean that buoy 12 can have means for transmitting and receiving data from a network, including but not limited to a radio network, and intranet, an internet server that can be connected to the internet, and so on. The buoys 12 can be spaced apart by a predetermined distance “d”. The buoys can be equidistant from each by the same distance “d”, or in other embodiments, it can be advantageous to space the buoys by different distances “dᵢ”, for example, if the harbor topography or geography make it advantageous to do so. As long as each distance dᵢ is known, the systems and methods for harbor detection can be effective. The buoys 12 can be moored to the harbor bottom at a predesignated location with an anchor, piling or similar type of structure (not shown in the Figures). Buoys 12 can placed in a straight line with a set distance d of 1 to 50 meters, depending on type, size, speed, and direction of the expected moving object, as well as the size and typical weather conditions of the harbor to be surveyed, and the anticipated amount of harbor vessel traffic.

As shown in FIGS. 2-3, vessel 15 passing through the harbor can generate a Kelvin wake. As the Kelvin wake propagates, it can reach the buoys and act on the buoys 12. The buoys 12 can have six degrees of motion: heave, sway, surge, roll, pitch and yaw. The first three are translational motion degrees of freedom, heave can be in the vertical direction, while sway and surge can be in the horizontal directions (for example, the x-axis and y-axis respectively, as shown in FIG. 3). Rolling is a rotation around a longitudinal axis (x-axis), pitching is a rotation around the transverse axis (y-axis) and yawing is a rotation around the vertical axis (z-axis). As the buoy(s) move in one or more the degrees of motion, that motion can be recorded within the buoys as buoy position data.

As shown in FIG. 3, each buoy 12 can be in wireless communication with a receiver 14 for receiving buoy position data, which can be sent from each buoy 12. A processor 16 can receive the aggregate buoy position data, and using non-transitory written instructions, can provide a determination as to whether the buoy position data indicates the presence of vessel 15. The determination can be shown at display 18. The instructions can be in the form of a fuzzy neural network. Fuzzy neural network algorithms can be thought of as a learning machine that finds the parameters of a fuzzy system (i.e., fuzzy sets, fuzzy rules) by exploiting approximation techniques from neural networks. Fuzzy neural network can be used for the systems and methods of the present invention because in the real world, all physical systems and nature behaviors are non-linear (fuzzy). Fuzzy neural networks can be the only algorithm that can have hybrid learning capacity using both raw fixed buoy data and generalized linguistic terms that describe behaviors of output classes (such as speed, proximity and heading, type of the vessel.) As such, fuzzy neural networks can be the only available algorithm able to describe a mathematical function from learned relationships. The algorithm can use data from consecutive asynchronous 3D movement of the water and correlates it with moving object descriptors.

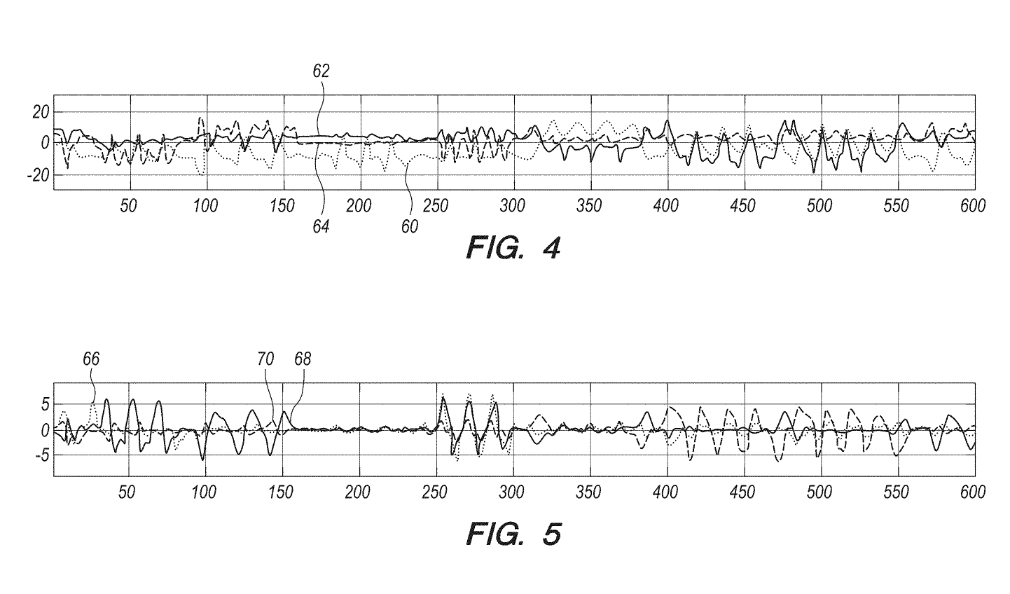

As an example of the above, different object that create wakes on the surface of the water have different characteristics, for example speed of vessel 15 can create the Kelvin wake with sharp consecutive asynchronous movement recorded by accelerometer and gyroscope placed on the buoys. Slower speed boats will record gentle movement trends and slower wave decay. For example, if the speed of the boat is 12 mph, and it passes buoy array 10 feet away, the data patterns depicted in FIG. 4 and FIG. 5 can be created. Curves 60, 62 and 64 in FIG. 4 can depict translational acceleration data for this scenario in the x-, y- and z-directions, respectively. Curves 66, 68 and 70 in FIG. 5 depict yaw, roll and pitch, respectively, over a 10 minute period. Table 1 below is a listing of the graphed data from FIGS. 4-5 over the first 6 seconds of the curves in FIGS. 4 and 5:

TABLE 1
Translational Acceleration Versus Time

| | Buoy 1 (sec) | | | | | | |
|---|---|---|---|---|---|---|---|
| | 00:00 | 00:01 | 00:02 | 00:03 | 00:04 | 00:05 | 00:06 |
| Acc X (m/s2) | 15 | 10 | 14 | −20 | −15 | −12 | 15 |
| Acc Y (m/s2) | −15 | −12 | −12 | −20 | −15 | −14 | 13 |
| Acc Z (m/s2) | 10 | 4 | −12 | −20 | −13 | 15 | 20 |
| Yaw (deg/s) | 3 | 3 | −3 | 5 | 6 | 7 | −3 |
| Roll (deg/s) | 3 | −5 | −7 | 2 | −5 | −1 | −1 |
| Pitch (deg/s) | −2 | −5 | −8 | 1 | 2 | 0 | −3 |
| Compass | SW | W | W | 3 | ES | ES | W |

Each buoy 12 can record the data due to its motion caused by the Kelvin wave, in order to determine to the sensing acceleration and direction of the Kelvin wakes (and by extension, the course and speed of the vessel 15 that caused the Kelvin wake). Depending on the purpose of use, pattern of placement, and area surveillance, multitudes of these buoys 12 can be used to map natural and man-made Kelvin Wakes.

### Object's Data

Data from the array of buoys 12 can be correlated with the experimental data which may have been previously taken and recorded. The experimental data can include measurement of asynchronous movement of buoy arrays, with recorded data of known object characteristics. One such object characteristic can be speed. Speed can be a categorical representation of objects speed on the surface of subsurface of the water. For the simplicity of calculations speed then categorized into 3 different speeds such as low (0 to 25 mph), medium (25 to 35 mph) and high above (35 mph and above). Another such characteristic can be proximity. Proximity can be a categorical representation of the position of vessel 15 on the surface or subsurface of the water relative to at least one of the buoys 12. For the simplicity of calculations the proximity is then categories into 3 different measures such as: close (up to 10 feet), medium (10-40 feet) and far (40 and above).

Another object characteristic can be heading. Heading can be the angle between the direction in which the vessel 15 is moving and a reference direction of the line of buoy arrays. (Typically true north, but other cardinal directions or headings could be used. The size of vessel 15 can be represented by the physical size recorded in feet (6 feet) controlled by the motor, wind or human power. Using these object characteristics, alternative result data can be generated by the systems and methods of the present invention. The alternative data can be illustrated in Table 2 below.

TABLE 2
Object Result Data

| | Object 1 (sec) | | | | | | |
|---|---|---|---|---|---|---|---|
| | 00:00 | 00:01 | 00:02 | 00:03 | 00:04 | 00:05 | 00:06 |
| Speed (mph) | 15 | 10 | 14 | 20 | 15 | 12 | 15 |
| Proximity (feet) | 5 | 10 | 20 | 10 | 15 | 14 | 13 |
| Heading (deg) | 10 | 4 | −12 | −20 | −13 | 15 | 20 |
| Compass (deg) | SW | W | W | 3 | ES | ES | W |

### Artificial Neuro-Fuzzy Algorithm

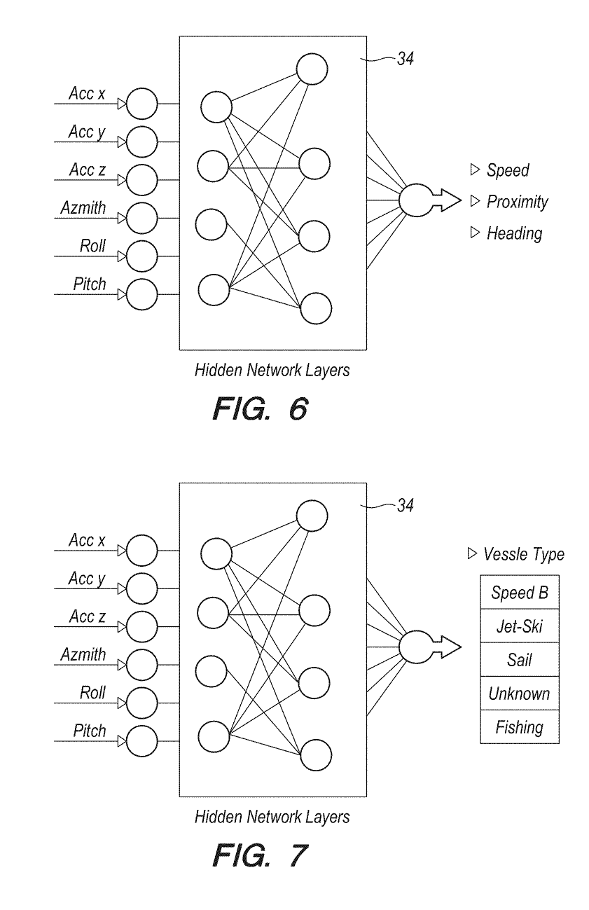

Referring now to FIGS. 6-7, all the data cited assembled supplied to an artificial neuro-fuzzy (ANF) algorithm (as used herein, “ANF” and fuzzy neural can be taken to mean the same thing). The input data represents temporal displacement of buoy 12. The output data can represent the observable object characteristics. The data obtained from buoy 12, which has been placed on subsurface of the water, is observable and “learned”.

In an alternative embodiment, and referring now to FIG. 7, the input data can be the data of Kelvin wakes recorded by array of buoys 12 that can correlate to the type of the vessel producing wakes, recording non-linear wake timing interval characteristics of Kelvin patterns, at known speeds, proximities and headings.

The box 34 in FIGS. 6-7 of the algorithms can be representative of the following logic. The data of at least 30 min of input-output pairs have been supplied into Artificial Neuro Fuzzy Algorithms for training. Each data input-output pair can have the following relation, described by a formula:

Outᵢ=σ(AccX*w₁+AccY*w₂+ . . . Pitch*w₆+θ), where
θ—is the bias;
w—is the weight assigned to the six degrees of freedom in the formula;
σ—is a sigmoid activation function

$$σ ( x ) = \frac{1}{1 + {e}^{- x}} ;$$

and,
AccX—data point representing acceleration over X plain.

To train, test and use the system 10 to use available data, a fuzzy neural back-propagation algorithm can be used. Once such algorithm can be described in a paper by Iryna Petrosyuk, entitled “Neuro-fuzzy Model for Image Processing in Electro-optical Applications,” 2006 International Conference—Modern Problems of Radio Engineering, Telecommunications, and Computer Science, Lviv-Slavsko, 2006, pp. 218-221. The contents of the Petrosyuk paper are hereby incorporated by reference herein.

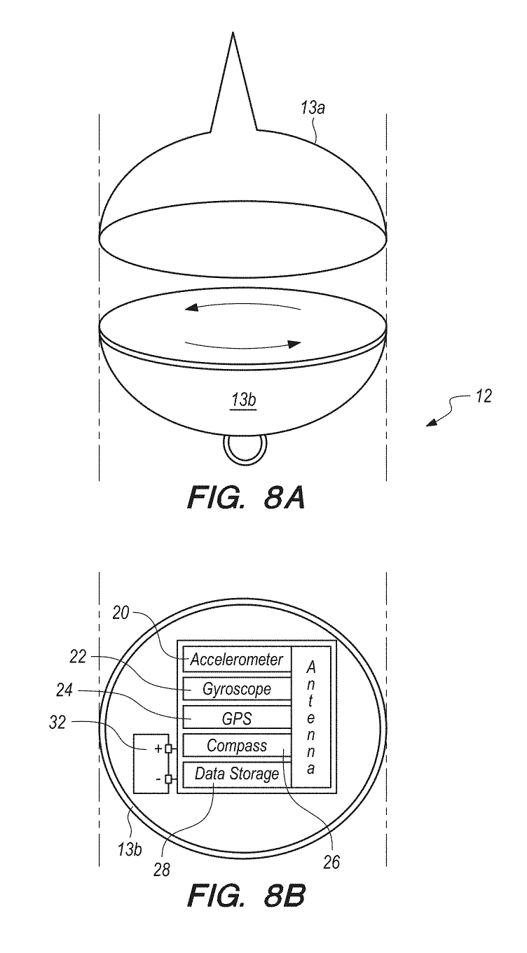

Referring now to FIGS. 8A-8B, the internal components of each buoy 12 can be seen in greater detail. Buoy 12 can include an upper buoy portion 13a as shown in FIG. 8A, and a lower buoy portion 13b, as shown in FIG. 8B. Each buoy 12 can further include an accelerometer 20, a gyroscope 22, a Global Position Satellite (GPS) component 24, a compass 26, and data storage 28. These components can be fixed to lower portion 13b (or to upper portion 13a if more convenient). The accelerometer and compass components can the LSM6DS33 and LIS3MDL Carrier models manufactured by Pololu Robotics and Electronics, while the gyroscope could be a Pololu MinIMU-9v5. Other vendors that provided similar components could be used. The accelerometer 20, gyroscope 22, a Global Position Satellite (GPS) component 24 and compass 26 can provide buoy position data either directly to an antenna 30 (A Pololu 66-Channel LS30031 by Pololu could be used for the antenna) for transmission to receiver 14, or to data storage 28 if antenna is temporarily inoperative, or to both data storage 28 and antenna 30 simultaneously. A power source 32 can be used to provide power to the buoy components. The power source can be a renewable type, which can use either solar power, or power which can be generated from the wave motion of the buoy 12. The buoy 12 can be an efficient, lower cost sensor that requires very little or even no maintenance once the buoys are placed in the system.

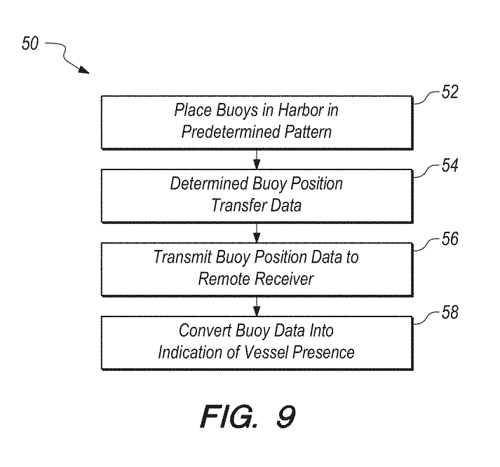

Referring now to FIG. 9, a block diagram 50 is shown, which can be used to describe the methods of the present invention according to several embodiments. As shown, method 50 can include the initial step 52 of placing buoys in a harbor in a predetermined pattern. The pattern can be a straight line of equidistant buoys 50, or it pattern could be customized according to considerations such as number of buoys available and harbor geography, as long as the spacing distance dᵢ and pattern geometry is known and is accounted for in the fuzzy neural network algorithm used by processor 16. Next, the methods 50 can include the step 54 of determining buoy position data. The buoy position data can be determined using the structure and cooperation of structure described above for buoys 12.

The methods 50 can further include the step 56 of transmitting buoy position data to a remote receiver 14. Then, and as shown by step 58, the buoy data can be converted into an indication of vessel presence in the harbor. The conversion can be accomplished by a fuzzy network neural algorithm. Other types of algorithms could also be used to accomplish the method according to several embodiments.

From the above, it can be seen that Kelvin wake phenomena can have a waveform that can be measured using traditional signal processing techniques. The Kelvin wake travel parameters can be measured by the buoy as buoy movements along the buoy degrees of freedom (which are caused by the Kelvin wake) as buoy position data. The buoy(s) position data set(s) readings can be sent by RF, cellular signal or fiber optics to the server via receiver 14. These signals are analyzed in real-time by a fuzzy neural network algorithm. Once man-made patterns are detected the server sends out notification, which can be seen at display 18 by a remote operator (not shown).

The present invention according to several embodiments can provide several advantages. Embodiments of this invention can use a low power, low cost array of buoys that can detect and recognize Kelvin wake patterns and send real-time notifications automatically, without human intervention. In addition, because of image and video recording of radar imagery ships wakes are seen at better accuracy then the actual ship imagery, there is a high need to be able to recognize ship's types from the Kelvin Wake pattern alone. As described above, processor 16 can further utilize an adjustable fuzzy neural network algorithm that can be aware of and respond to changing environmental and vessel traffic conditions.

The advantages of this method can further include the use of a low power, renewable energy source; gives real-time notifications on time type, size, speed and direction of moving object. Other methods are limited in low visibility (image and video records) can require substantial power or human operator. Still other embodiments of the present invention can be used as a method to monitor movement on water surface for purposes such as drug trafficking, pool safety, renewable energy source, farm fishing, marine species monitoring and littoral security. Such systems can be used by a low power, low cost array of buoys that can detect and recognize Kelvin wake patterns from naturally occurring surface and internal waves and send real-time notifications automatically, based on an analysis of those wave patterns. These systems can also be deployed autonomously and be discretely placed along shorelines.

The use of the terms “a” and “an” and “the” and similar references in the context of describing the invention (especially in the context of the following claims) is to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of the preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A surveillance system, comprising:
a plurality of buoys;
each said buoy having means for determining buoy position data transfer data and a transmitter for transmitting said position data;
a means for receiving said buoy position data; and,
a processor, said processor having non-transitory written instruction for converting said buoy position data into an indication of the presence of a vessel.

2. The system of claim 1, wherein said indication is positive, and buoy position data is generated by motion of said buoys, and said motion of said buoys is caused by a Kelvin wake generated by said vessel.

3. The system of claim 2, wherein said buoys are equidistant from each other.

4. The system of claim 2, wherein said buoys are not equidistant from each other, but further wherein said each buoy has a known distance “dᵢ” and said written instructions incorporate said known distance dᵢ in generating said algorithm.

5. The system of claim 1, wherein said buoys are submerged.

6. The system of claim 1, wherein said algorithm is a fuzzy neural network algorithm.

7. A method for conducting harbor surveillance comprising the steps of:
A) placing a plurality of buoys in said harbor in a predetermined pattern;
B) determining buoy position data transfer data for each said buoy from said step A)
C) transmitting said position data from said step B) a receiver; and,
D) converting said buoy position data into an indication of the presence of a vessel in said harbor.

8. The method of claim 7, wherein said indication from said step D) is positive, and buoy position data from said step B) is generated by motion of said buoys, and said motion of said buoys is generated by a Kelvin wake generated by said vessel.

9. The method of claim 7 wherein said predetermined pattern from said step A) is a line with said buoys are being equidistant from each other.

10. The method of claim 7, wherein said predetermined pattern from said step A) is a line with said buoys not being equidistant from each other, but further wherein said each buoy has a known distance “dᵢ” and said step D) is accomplished using written instructions that incorporate said known distance “dᵢ”.

11. The method of claim 7, wherein said steps A) is accomplished with said buoys that are submerged.

12. The method of claim 7, wherein said step D) is accomplished using a fuzzy neural network algorithm.
